(19) United States
(12) Patent Application Publication
(10) Pub. No.: US 2009/0172402 A1
(43) Pub. Date: Jul. 2, 2009

(54) Multi-factor authentication and certification system for electronic transactions

(76) Inventor: Nguyen Tho Tran, Ho Chi Minh City (VN)

Correspondence Address: TUE NGUYEN, 496 OLIVE AVE, FREMONT, CA, 94539, US

(21) Appl. No.: 12/346,822

(22) Filed: Dec. 30, 2008

Related U.S. Application Data
(60) Provisional application No. 61/018,440, filed on Dec. 31, 2007.

(51) Int. Cl. H04L 9/32; H04L 9/00; H04L 9/28; G06Q 20/00

(52) U.S. Cl. 713/170; 705/40

(57) ABSTRACT

The present invention provides computer-enable certification and authentication in, for example, e-commerce with wireless and mobile devices. The present authentication method offers ease of operation by automatically embedding a one-time passcode to the message without the sender input. A one-time key can also be used to encrypt the message, further providing transmission security. In addition, sensitive information and one-time passcode generator are pre-arranged and stored at both sender and receiver devices, avoiding information comprising in wireless environment transmission.

This application claims priority from U.S. provisional patent application Ser. No. 61/018,440, filed on Dec. 31, 2007, entitled “Multi-factor authentication and certification system for electronic transactions transmitted by remote devices”, which is incorporated herein by reference.

### FIELD OF THE INVENTION

The present invention relates to methods and devices for secure transmission of information, and particularly to authentication methods and systems using wireless or mobile devices.

### BACKGROUND OF THE INVENTION

Commercial transactions require some type of identity authentication to verify that an individual is authorized to conduct such a transaction. For an important “order” or transaction, it is necessary to authenticate the party to the transaction. For example, with transactions conducted in-person, a person may establish identity by presenting an ID card with a picture and/or a signature. The person can then sign documents to validate his identity.

In recent times, remote transactions have become popular, for example, with the introduction of Internet shopping and banking transactions. Internet shopping can provide remote merchandise shopping as well as other forms of transactions such as betting or game playing. Internet banking can also provide account and fund information, bill payments, account transfer, and even stock trading.

Remote transactions generally require authentication and transferring of confidential information, which is a major obstacle in the widespread implementation and usage of online transactions. Stores or banks need to be sure that the customers are who they say they are to prevent fraudulent transactions. And the customers want to know that their personal and confidential information are not exposed.

Thus in the modern world of remote commerce transactions, the challenge presented is how to authenticate and how to prevent information exposure when a party to the transaction is using a wireless or other mobile device. In addition to authentication procedures, another challenge raised it how to certify to all participating parties that the transaction itself is non-refutable.

In general, authentication is the process of verifying the identity of the user, for example, by using a username and a static password. Static password is a widely used authentication mechanism, but is usually a weak authentication system. Tokens (e.g., computer-based key devices) and smart cards offer a robust solution for a better authentication process. Prior art approaches to improve authentication also include manual entry by the customer or electronic distribution at the point of sale. This approach can require a difficult key distribution mechanism for the customer, or an unacceptable level of participation from an untrusted sales agent.

Authentication systems have evolved significantly over the years but most of the solutions focus on how to encrypt the authentication information before transmitting it over a phone link. However, as any expert can testify, there is no encryption technology that is unbreakable; it is only a matter of time before it may be compromised. Authentication by biometry such as finger prints, or retinal analysis, or by facial recognition is only good for local use. For remote usage, the risk of breach is high.

Thus, there remains a potential risk in conducting remote or over-the-air transactions that unaffiliated third parties could maliciously capture sensitive information. Therefore, parties to a transaction want to prevent third parties from stealing authentication information traveling on a phone link, phone line, or wirelessly as that could later be used to conduct a fake transaction or alter an existing one.

Recently, technology called “One Time PIN/Password” or “OTP” has been adopted by many providers in the online banking system. This is similar to traditional static passwords in that they are used in conjunction with a usemame, but are instead generated dynamically using a hardware token. At each session, the client to the transaction uses a physical OTP device to generate a unique multi-digit PIN. In subsequent sessions, yet another unique PIN is generated. These PINs are synchronized with a central server, so that the client is authenticated as the one who possesses the OTP device. This solution, as currently deployed, is good for online systems. But when the same approach is applied to wireless devices using popular text messaging, it requires a user to conduct many steps to complete a transaction. Furthermore, the system fails should the client lose the OTP device. For example, a prior art OTP system for mobile phone generates an OTP when the user requested. The user then can input and transmit the OTP to the server to authenticate the transaction.

FIG. 1 illustrates a prior art authentication for a mobile device. The user uses a mobile device to send a message, for example, a request for payments, to the server. In order to authenticate the message, the server uses an Instant Voice Responder module to send a challenge back to the user. The user captures the challenge on the mobile device, which then uses it to generate the OTP and transmitted it back to the server. Prior art hand-held devices generating OTP thus are cumbersome and the algorithm to generate the OTP is not secure.

### SUMMARY

The present invention provides computer-enable certification and authentication in, for example, e-commerce with wireless and mobile devices. In an aspect, the present authentication and certification use a strong multi-factor (more than 2) authentication method and application software embedded in the mobile device, allowing the issuer of a transaction request to become authenticated, to have his status verified, to have his order non-refutably certified and executed without any addition input from the issuer.

In an embodiment, the present invention describes systems and methods to permit a sender, with a mobile device, to send messages, such as transaction requests, to a receiving server. The receiving server must recognize and authenticate the sender and/or the sender device, for example, verifying that the sender has all the right factors which are registered, and/or assigned by, the server to execute certain types of transactions, certifying that this transaction request was sent by an approved mobile device, and then sending confirmation receipt at the execution of the transaction. In an embodiment, the present invention discloses methods and apparatuses to authenticate and certify messages sent from a sender or a sender device, such as a cell phone. The present invention further provides ease of operation, for example, by automatically embedded an authenticate passcode to the message, all without the sender's intervention. The passcode is preferably a one-time passcode, which can further enhance the security of the authenticate process. In an embodiment, the present authenticate comprises composing a message at a sender or a sender device, such as a mobile phone, and then sending the message and a sender identity to a receiver device, such as a server. Before sending the message, a one-time passcode is automatically generated and embedded to the message without any sender's input. The one-time passcode serves to authenticate the message, certifying that the message is indeed generated from the sender or the sender device. After an authentication process, a confirmation is received to acknowledge the message. In an aspect, the present authentication process further provides that the one-time passcode is recorded with the message, thus enabling certification that the message has been authenticated.

In an embodiment, the present authenticate method comprises composing a message, then automatically generating a one-time passcode without any sender's input. The automatically generated one-time passcode is then automatically embedded in the message, again without any sender's input. When the sender presses a send button, the message, including the embedded one-time passcode, is sent to a receiver device. The one-time passcode is generated and embedded automatically when the sender sends the message, thus simplify the process of secure communication between the sender/sender device and the receiver devices. In an aspect, the one-time passcode is preferably generated from an embedded algorithm utilizing one or more features unique to the sender and the sender device. For example, the features can be a phone number of the sender mobile device, an International Mobile Equipment Identity (IMEI), a unique industrial ID number of the mobile device, for example, in case of GSM or UMTS devices, a particular version of the one-time passcode algorithm, a unique security key for the receiver device, a password chosen by the receiver device, or the date and time of sending. The features can also be personal information of the sender/sender device, for example, birthday, social security, or a password, such as an alphanumeric password or a biometric password.

In an aspect, the sender/sender device identity is also sent, preferably automatically, when the message is sent. The sender/sender device identity can be the phone number of the sender/sender device, and can be sent to announce the coming of the message (for example, similar to the standard practice of caller identification process), or can be embedded in the message to be sent together.

In an embodiment, the present authentication method is utilized in an unsecured environment, for example, in a wireless or mobile phone network. To provide further security, the sender can login to a server account, for example, a financial institution such as an online banking. The login process can also constitute a password, for example, an alphanumeric or a biometric password. After composing a message, a one-time passcode is then automatically generated and embedded to the message. Before sending the message, the sender can input another password to confirm the message sending. The passwords, provided at the account login and at the sending confirmation, can serve to provide a secure environment, for example, against the loss of the mobile device.

In an aspect, the present authenticate method further comprises an encryption process for secure message transmission. For example, a standard encryption can be applied to the message before sending. In addition, a one-time key encryption can be applied to the message to further increasing the security of the coded message. The one-time key can be generated at the mobile device, for example, using information unique to the mobile device or the sender. The information for the one-time key can be received from the server, for example, included in the previous confirmation, and extracted for the next transaction encryption.

In an embodiment, the present authenticate method comprises pre-arranged information between the sender/sender device and the receiver devices, thus avoids sending sensitive information, especially in unsecured environments such as wireless or telephone network. The present method comprises only sending a message including a one-time passcode and a sender/sender device identity. The one-time passcode is generated from an algorithm embedded in the sender device, with the algorithm utilizing one or more features stored in the sender device. The one or more features are pre-arranged to also be stored in an account at the receiver, which can be identified by the sender/sender device identity. In addition, the algorithm can also be pre-arranged, e.g., having the same algorithm, between the sender/sender device and the receiver so that a same one-time passcode is generated with the same inputs of the one or more features.

In an aspect, the pre-arranged one-time passcode generator allows an authentication process without transferring any sensitive information. Information has been already shared between the sender/sender device and the receiver, and therefore only a sender/sender device identity is needed to pull the sender account for accessing the stored information. Personal information of the sender/sender device can be stored, as well as non personal information such as the date and time of the message transaction.

In an embodiment, the present authenticate method comprises a receiver device, such as a server for receiving the authenticate message sent from a sender/sender device. The receiver device comprises modules and processes to authenticate a message sent from a sender/sender device, especially in an unsecured environment. The present method comprises a receiver device receiving a one-time passcode, together with a sender/sender device identification. A matching one-time passcode is retrieved by the receiver, for example from an algorithm utilizing one or more information stored in an account identified by the sender/sender device identification. If the matching passcode matches the one-time passcode, the identity of the sender/sender device is authenticated, and a confirmation is sent back to the sender/sender device, acknowledging the message. The algorithm can be embedded in the receiver device, and thus the receiver device generates the matching passcode from the embedded algorithm. The algorithm can be stored in an authenticate server where the receiver device will send an authenticate request and the sender/sender device identification to validate the one-time passcode. After receiving the authenticate request with the sender/sender device identification, the authenticate server will generate a matching passcode from the embedded algorithm, utilizing the information stored in the account identified by the sender/sender device identification. The generated matching passcode will be transmitted to the receiver device, where if the matching passcode matches the one-time passcode, a confirmation will be sent back to the sender/sender device.

The matching passcode can be generated from an algorithm embedded in the receiver device or in the authenticate server, with the algorithm utilizing one or more features stored in an account at the receiver/authenticate server which can be identified by the sender/sender device identity, and also stored in the sender device. The algorithm is also pre-arranged between the sender/sender device and the receiver/authenticate server so that a same one-time passcode is generated with the same inputs of the one or more features.

The present invention further discloses a mobile device, such as a cell phone, or a personal device assistance (PDA) for transmitting authenticate message. The mobile device comprises a communication module for transmitting and receiving message; a keypad module for composing message with the keypad module comprising a send button for sending a message; a one-time passcode generator employing one or more features stored in the mobile device, such as features unique to the mobile device, or information related to the sender/sender device; and a processor for automatically generating and embedding a one-time passcode to a message before sending. The present invention further discloses a server for authenticate received message. The server comprises a communication module for transmitting and receiving message; a module for extracting a sender/sender device identification and a one-time passcode from the message; a one-time passcode generator employing one or more features stored in an account identified by the sender/sender device identification; and a processor for automatically generating and comparing a one-time passcode to a generated matching passcode. Other embodiments can be provided, for example, a system comprising an authenticate server and a plurality of mobile devices for secure transmission of messages.

### BRIEF DESCRIPTION OF THE DRAWINGS

FIG. 1 illustrates a prior art authentication for a mobile device.

FIG. 2 shows a schematic block diagram of an exemplary operating environment for a system configured in accordance with the present invention.

FIG. 3 shows a schematic block diagram of an exemplary computing environment with which the present invention can interact.

FIG. 4 illustrates an exemplary embodiment for authenticating transmitting messages.

FIG. 5 illustrates an exemplary system for secure transmission of message between a mobile device and a receiver server.

FIG. 6 illustrates another exemplary system for secure transmission of message, including an authenticate server.

FIG. 7 illustrates an exemplary mobile device according to an embodiment of the present invention.

FIG. 8 illustrates an exemplary receiver server according to an embodiment of the present invention.

FIG. 9 illustrates an exemplary receiver server communicating with an authenticate server.

FIG. 10 illustrates an exemplary process for authenticating transmitting messages.

FIG. 11 illustrates another exemplary process for authenticating transmitting messages.

FIG. 12 illustrates another exemplary process for authenticating transmitting messages.

FIG. 13 illustrates another exemplary process for authenticating transmitting messages.

FIG. 14 illustrates an exemplary process for authenticating a received message.

FIG. 15 illustrates another exemplary process for authenticating a received message.

FIG. 16 illustrates another exemplary process for authenticating a received message.

FIG. 17 illustrates another exemplary process for authenticating a received message.

FIG. 18 illustrates an exemplary multi-factor OTAC generator according to an embodiment of the present invention.

FIG. 19 illustrates an exemplary environment of the present OTAC process.

FIG. 20 illustrates an exemplary OTAC level 2 authentication and certification process according to an embodiment of the present invention.

FIG. 21 illustrates an exemplary OTAC level 3 authentication and certification process according to an embodiment of the present invention.

FIG. 22 illustrates an exemplary environment of the present invention.

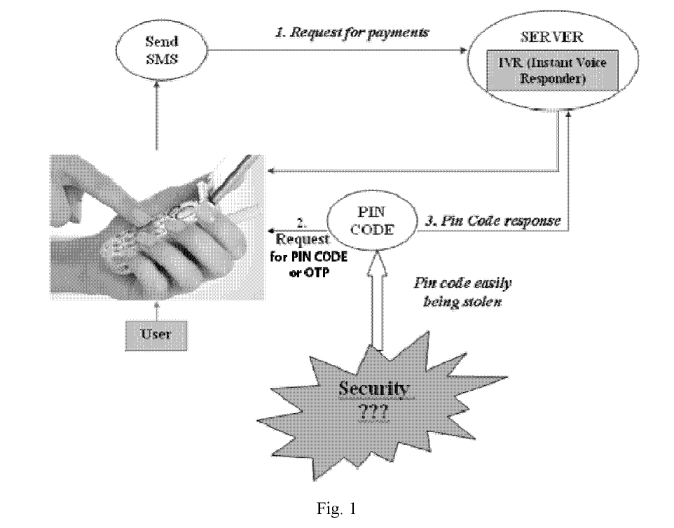

### DETAILED DESCRIPTION OF THE PREFERRED EMBODIMENTS

The following description and drawings are illustrative of the invention and are not to be construed as limiting the invention. Numerous specific details are described to provide a thorough understanding of the present invention. However, in certain instances, well known or conventional details are not described in order to avoid obscuring the description of the present invention. References to one or an embodiment in the present disclosure are not necessarily references to the same embodiment; and, such references mean at least one.

In an embodiment, the present invention discloses methods and apparatuses for authenticating transaction messages, including generating proof for the transactions. In an aspect, the present method comprises automatically generating and embedding a one-time-passcode (OTP) to the transmitted message, thus providing ease of operation for the sender. In addition, the use of OTP provides a secure transmission process against fraudulent usage. In an aspect, the present method comprises using an OTP generated from an embedded algorithm using one or more features stored in the sending device. The algorithm is shared with the receiving server, and the features are also stored in an account of the sender/sender device at the receiving server. The use of pre-arranged algorithm and information provides an added security of preventing sensitive information transmission. Further, the features stored in the sender/sender device can be unique to the sender device, thus also preventing personal data exposure. In an aspect, the present process further comprises alphanumeric or biometric password protection, for example, to prevent unauthorized usage of the mobile device. The OTP code further can enable the certification of the message by recording it together with the message.

In an embodiment, the present invention discloses mobile devices, receiving servers, and authenticate servers for carrying the present authentication process. The mobile devices and the receiving servers can include pre-arranged OTP algorithm software, together with shared information for OTP algorithm inputs. The mobile device according to the present invention includes any computation unit having a wireless communication capability, for example, a handheld mobile device, a cell phone, a PDA (personal device assistance), a pocket PC, a PC phone, a smart phone, a laptop, and a movable computer or server,

The present invention provides a computer-readable recording medium on which a program and data are recorded and which when executed by a data processing system causes the system to perform various methods of the present invention, such as when a plurality of user devices and servers are interconnected over a network. The present invention may also be embodied in a machine or computer readable format, e.g., an appropriately programmed computer, a software program written in any of a variety of programming languages. The software program would be written to carry out various functional operations of the present invention. Moreover, a machine or computer readable format of the present invention may be embodied or stored in a variety of program storage devices, such as a diskette, a hard disk, a CD, a DVD, a nonvolatile electronic memory, or the like. The software program may be run on a variety of devices, e.g. a processor.

Thus, a machine readable medium includes any mechanism that provides (i.e., stores and/or transmits) information in a form accessible by a machine (e.g., a computer, network device, personal digital assistant, manufacturing tool, any device with a set of one or more processors, etc.). For example, a machine readable medium includes recordable/non-recordable media (e.g., read only memory (ROM), random access memory (RAM), magnetic disk storage media, optical storage media, flash memory devices, etc.), as well as electrical, optical, acoustical or other forms of propagated signals (e.g., carrier waves, infrared signals, digital signals, etc.), etc.

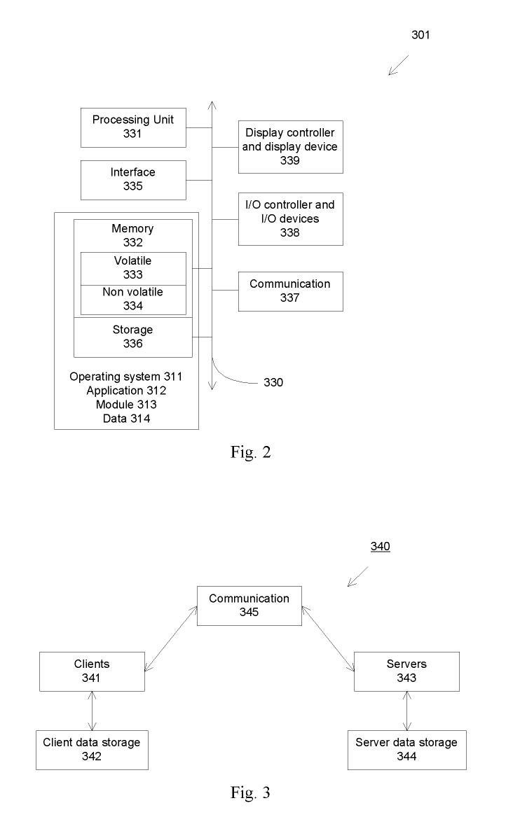

FIG. 2 illustrates an exemplary system, such as a computer or a mobile device system 301 which may be used with the present invention. Note that while FIG. 2 illustrates various components of a computer system, it is not intended to represent any particular architecture or manner of interconnecting the components as such details are not germane to the present invention. It will also be appreciated that network computers and other data processing systems which have fewer or more components may also be used with the present invention. The system of FIG. 2 may, for example, be a mobile device, a cell phone, a PDA, or a computer or server. The system 301 comprises a processing unit 331, a system memory 332, and a system bus 330. The processing unit 331 can be any of various available processors, such as single microprocessor, dual microprocessors or other multiprocessor architectures. The system bus 330 can be any type of bus structures or architectures. The system memory 332 can include volatile memory 333 and nonvolatile memory 334. System 301 also includes storage media 336, such as removable/nonremovable, volatile/nonvolatile disk storage, such as magnetic disk drive, optical disk drive, or memory drive. A removable or non-removable interface 335 can be used to facilitate connection.

It will be apparent from this description that aspects of the present invention may be embodied, at least in part, in software. That is, the techniques may be carried out in a system or other data processing system in response to its processor, such as a microprocessor, executing sequences of instructions contained in a memory or a remote storage device. In various embodiments, hardwired circuitry may be used in combination with software instructions to implement the present invention. Thus, the techniques are not limited to any specific combination of hardware circuitry and software or to any particular source for the instructions executed by the data processing system. In addition, throughout this description, various functions and operations are described as being performed by or caused by software code to simplify description. However, those skilled in the art will recognize what is meant by such expressions is that the functions result from execution of the code by a processor.

The system 301 further can include software to operate in environment 300, such as an operating system 311, system applications 312, program modules 313 and program data 314, which are stored either in system memory 332 or on disk storage 336. Various operating systems or combinations of operating systems can be used. I/O controller and I/O devices 338 can be used to enter commands or data, and can include a keyboard or a pointing device, preferably connected through I/O controller interface ports. Display devices and display controller 339 such as video or sound cards are provided to connect to some external output devices such as monitors, speakers, and printers.

System 301 can operate in a networked environment with other remote devices, which typically includes many or all of the elements described relative to device 301. Remote devices can be connected to device 301 through a communication 337.

FIG. 3 is a schematic block diagram of a sample environment 340 with which the present invention can interact. The system 340 includes a plurality of client systems 341. The system 340 also includes a plurality of servers 343. The clients 341 and the servers 343 can be used to employ the present invention. The system 340 includes a communication network 345 to facilitate communications between the clients 341 and the servers 343. Client data storage 342, connected to client system 341, can store information locally. Similarly, the server 343 can include server data storages 344.

The present invention exploits the advance in computational power for a mobile device such as a cell phone to implement a robust authentication process, which includes an efficient, cost effective and secure key generation and distribution capability, while preserving sensitive information confidentiality. In addition, the present authentication process provides a convenient and transparent key distribution and generation mechanism to the user to facilitate easy adaptation.

In an embodiment, the present invention provides methods and systems utilizing mobile devices to secure the transmission of information. In accordance with an embodiment of the present invention, the mobile device automatically generates an OTP and automatically embeds the generated OTP to the message to send to a server. The OTP provides security against fraudulent usage. Further, the OTP can prevent sensitive information from being sent over the network, thus provides security against loss of sensitive information. Also, the OTP automation process provides the authenticate capability without any additional inputs from the user. The message can be a request for a transaction, for example, a request for information, a request for access, or a request to perform certain transactions.

In an aspect, the message is displayed on a display of the mobile device. However, the OTP is automatically generated and embedded without displaying. Thus the message is sent with the embedded OTP. The message is transmitted from the mobile device to the server, for example, using Bluetooth or infrared.

The OTP is for authentication of the sender/sender device. Once authenticated, the server can send a confirmation message, for example, to provide proof that the message has been authenticated and the instruction carried out. The server can also record the “order message” with the time and passcode for a non-refutable proof that the sender/sender device has been authenticated and has sent the message order at this time. If the authentication result was negative, the server can reply that authentication was denied, and thus, the requested transaction will not be performed.

There are many schemes for implementing OTP, for example, token-based schemes such as SecurID or ActivCard, or public domain schemes include S/Key or Simple Authentication and Security layer (SASL) mechanisms. The present invention includes generic OTP schemes. In a preferred embodiment, the generation of the present OTP comprises at least a number of features uniquely related to the mobile device's components, the user, or the server. For example, the features or factors include features physically related to the SIM card such as the phone number, features physically related to the mobile device such as the EMEI, features related to the user stored on the mobile device such as the personal algorithm for generating OTP, features related to the user not stored on the mobile device such as PIN password or biometric password, and features related to the server, such as seed Co sent by the server. The seed information can be changed each time by the server to further providing a security against the case where all other features are hacked and counterfeited.

In this application, the term “user” or “sender” refers to an end-user seeking to authenticate during transaction conductions or to access services and resources. The term “sender device” refers to the device that the sender uses in performing the transaction, such as a mobile device. Further, the term “sender” and “sender device” can be used interchangeably, and can be represented by “sender/sender device”. For example, a sender sends a message can be interpreted to mean a sender device sends a message, or a sender uses a sender device to send a message. The term “server” refers to institutions that will perform the requested transactions. These institutions may include retailers, merchants, banks, Internet banks, or any business offering controlled access to services or resources. The server might include authentication certification service providers offering authentication certification services to the transaction institutions.

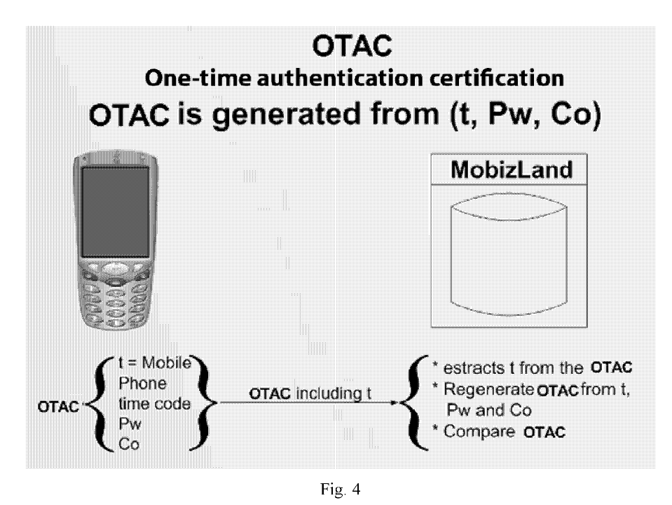

The authentication process of the present invention is based on multiple factors such as the characteristics of the mobile devices, and optional, the passwords and personal information. FIG. 4 illustrates an exemplary embodiment of the present one-time authentication certification (OTAC) process where the OTAC is generated from multiple factors, for example, from the mobile phone time code t, a password Pw chosen by the user, and a unique security key Co generated by the receiving server. The mobile phone can generate the OTAC when communicating with the receiving server MobizLand. When receiving the message with the OTAC, the receiving server can extracts the time t from the OTAC, and can generate a matching OTAC from the parameters t, Pw and Co. The matching OTAC is then compared with the received OTAC, and if matched, the receiving server sends a confirmation acknowledging the message and performs the instructions included in the message.

In an aspect, the security code Co is sent by the receiving server to the sender/sender device. For example, the security code Co for the next message can be included in the confirmation message of the previous message. Thus the number of messages exchanged between the sender/sender device and the receiving server can be kept to a minimum. Alternatively, a security code Co can be sent to the mobile device separately.

In an aspect, an OTP is computed by the mobile device based on pre-arranged information. The present process can provide an easy and simple means for a user to get authenticated, employing a secure algorithm to generate OTP, and generating OTP automatically for messages requiring authentication.

A one-time Password (OTP) method is a representative method for securing the security relating to authentication for using the service with the content described above and providing a convenience for the user. The one-time password method is a mode where a different password is generated each time a password is used as opposed to inputting a fixed password. In other words, the OTP is a randomly generated password and is different each time it is used. The OTP is not recorded in the mobile device to prevent fraudulent usage.

An authentication and certification system for transactions sent by wireless or mobile devices, using a strong multi-factor (more than 2) authentication method and application software embedded in the mobile device, allowing the issuer of a transaction request to become authenticated, to have his status verified, to have his order non-refutably certified and executed yet requiring only a single step from the issuer.

This document generally describes systems and methods that may permit a Remote Entity (RE) to send an Executing Server (ES) a transaction request through various types of Mobile Devices (MDs). This order also may be sent by text message. The ES must recognize and authenticate the RE, verify that this entity has the right to request a certain type of transaction, certify that this transaction request was sent by this RE, and confirm receipt by the ES at the execution of the transaction.

There are many methods to authenticate the RE, but it must be done in a way that one cannot falsify the RE. Some methods require transmission of the RE's identity information from the remote device (RD) to the ES until the latter has enough factors to identify and authenticate the RE. When private or confidential information is sent through the phone, through an electronic link, or over the air, one has to encrypt it because it may be easily stolen. But unbreakable encryption doesn't exist yet. So any method which sends encrypted critical information over the phone or other electronic links are not secure.

To solve the above problems, in an embodiment, the present invention doesn't send critical information over phone or electronic links, and the authentication code (AC) that is sent with the order is generated for each session, by application software which is embedded in the MD. The AC is only valid for a single session. This embedded application software is called the AC generator (ACG). With this method, third party theft of codes is not a concern because the codes will not be valid for any subsequent sessions. Furthermore, this method may not require the need for encryption since security is already at the highest level.

In an embodiment, to increase the security of the authentication process, a one-time key encryption is applied to the transaction message. The one-time encryption process can be embedded in the mobile device, utilizing information unique to the sender or the sender device. The one-time key can be generated with information stored in the mobile device, or received from the server.

In an embodiment, in order to increase the accuracy of the authentication, the present invention utilizes an ACG algorithm which may be a function of at least five (5) personal and unique factors related to the RE such as:

1. Phone number of the MD (pn)

2. International Mobile Equipment Identity (IMEI): unique industrial ID number of each MD (im) (in the case of GSM or UMTS devices)

3. Particular version of the ACG algorithm for each RE (acg[RE])

4. Unique security key for each RE, generated by the ES (sk(RE))

5. Password chosen by the RE (pw(RE))

The invention is not limited by the number or type factors which may be utilized. More or fewer factors may be used. Alternatively, in the case of a CDMA or non-GSM wireless network, rather than using IMEI, the factor may be an Electronic Serial Number or MEID.

In an aspect, if tc is the unique time code generated from the full date and time of the transaction, the ACG algorithm can be formulated as follows: AC(tc)=acg[RE](tc, pn, im, sk(RE), pw(RE)). To have a unique version of the ACG algorithm for each RE, the ES can have an ACG algorithm generator (ACGAG).

At each session, the AC(tc) is generated, then sent to the ES, with the transaction request. The ES simultaneously receives the detailed information of the text message and the phone number of the text message sender/sender device. From this phone number, the ES retrieves from its data base, the RE's expected information, including the personal and unique factors, and then computes the AC(tc) to compare with the one it has received.

If they match, it means that the text message sender/sender device possesses all the personal and unique factors to be authenticated as the valid RE. As the AC is sent with the text message transaction request, it simultaneously certifies that this transaction request was sent by this RE and has been received by this ES at this time. This certification is nonrefutable.

The present invention provides better OTP authentication process since the standard or prior art OTP device is just a selector from a cyclic suite of semi-random 4 to 6 digit numbers. It uses as the only factor the fact that the RE possesses it.

In the present invention, the AC generator can be embedded as a software application inside the MD, using increased computing power to generate a more complex AC, which is a function of, at least, 5 personal and unique simultaneous factors. Also embedded in the MD is a user-friendly application software interface which makes the use of the MD to send the transaction request simple and quick. In this application, the RE need only key in a few corresponding fields, such as password, the transaction request in a pre-defined format for each type of transaction, and then press the “send” button on the device. That is all the RE must do to initiate a transaction.

At the time the user initiates a transaction, the application automatically generates the AC, adds it to the text message transaction request, and sends it to the messaging service number of the ES which is preprogrammed in the application. Receipt of the transaction request triggers all the processes handled by the ES: authentication, certification, verification of the RE's status, execution of the order, and then transmission of the result or the status of the transaction to the RE. With this system and method, the RE can remotely initiate a transaction and make it executed with only a single step, simply, easily, quickly and in an user friendly way, thus the RE is accurately authenticated without exposing its private and confidential information (very high anti-fraud level).

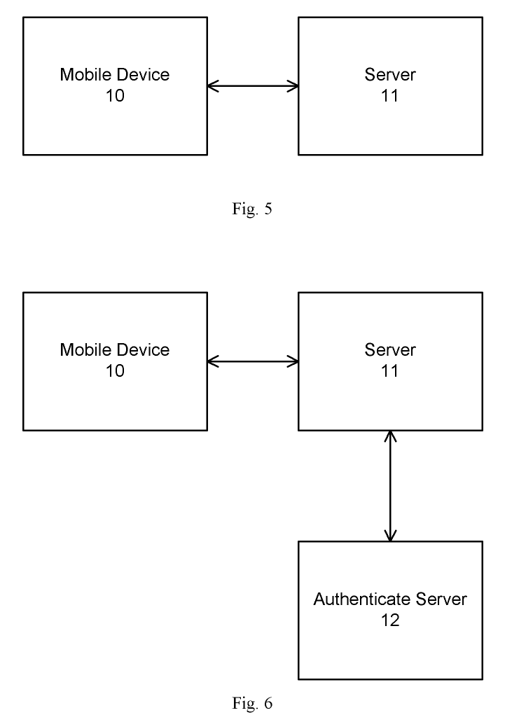

FIG. 5 illustrates an exemplary embodiment for authenticating transmitting messages, comprising a mobile server 10 communicating with a server 11. In an aspect, the mobile device 10 is utilized by a user or a sender who sends a message, such as transaction requests, to a receiving institution such as a merchant or a bank. The message is received by the server 11, and before the transaction is performed, the receiving server 11 must recognize and authenticate the message, for example, by verifying that the sender/sender device has the right to execute the requested transaction, by certifying that this transaction request was sent by an approved mobile device. After the sender/sender device 10 is authenticated, the server 11 can execute the transaction request, and at the same time, sending a confirmation receipt to establish proof.

The hand-held mobile device has become a popular communication tool worldwide. Furthermore, advanced functions and capabilities are continually being added to mobile devices. Such that a mobile device user can not only use the device for voice communication, but also for data storage, email, messaging, entertainment, camera, and personal organization. More advance features are also emerging for conducting online financial transactions using the mobile device as a credit card to pay bills or to buy goods and subscription services. The advancement of the hand-held device is propelled by both hardware and software technologies. Each new generation of mobile devices greatly increase the CPU speed and memory size enabling even further functionality. The present invention includes the development of code to authenticate users.

FIG. 6 illustrates another exemplary system for secure transmission of message between a mobile device 10 and a receiving server 11 with an authenticate server 12. In an aspect, the authenticate server 12 serves multiple receiving servers 11 to provide authenticate services. After receiving the message from the mobile device 10, the receiving server 11 extracts the OTP from the message, and sends the OTP to the authenticate server 12 for confirming the identity of the sender/sender device. Thus the receiving server 11 can be a simple and standard service provider with authentication service delegated to the authenticate server 12. The authenticate server serves one or more receiving servers that maintain a number of data stores that contain consumer data associated with respective consumer names to facilitate a rapid authentication of a consumer on the basis of the authentication data provided by the client.

The system is especially suitable for Internet applications where the client may be a business that needs to authenticate an end-user before it will grant access to a particular service or application. In particular, the system can be used in Internet banking applications where a bank requires authentication of a customer before granting access to the web site.

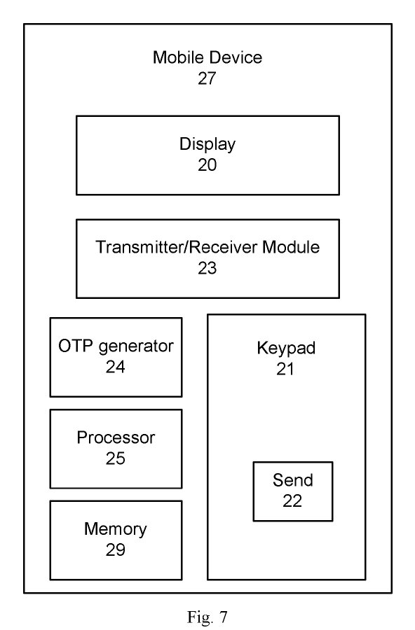

FIG. 7 illustrates an exemplary mobile device 27 according to an embodiment of the present invention. The mobile device 27 comprises a keypad (or keyboard) 21 and a display 20 to allow the user to compose the message, e.g., a transaction request, to be sent to the receiving server. The mobile device 27 further comprises an OTP generator 24 to generate an OTP to be included in the message. The mobile device 27 also comprises a transmitter and receiver module 23 to communicate with the receiver server. When the user finishes composing the message, the user can press a send button 22 to transmit the message, including the OTP. In addition, an ID of the user can be sent, either before or during the message. For example, in the case of the cell phone, a telephone number identified the mobile device can be sent before the message. The send button 22 can be a separate send button, or can be a part of the keypad 21. The mobile device 27 also comprises a processor 25, for example, to run and coordinate all other modules. Other module can be included, such as a memory 29 for storing information and a biometric password module (not shown).

In an embodiment, the user can establish a communication channel before composing the message. For example, the user can dial to the receiving server, and login to an account at the receiving server. The identity of the mobile device can be the telephone number, the account identification, or can be the user identification needed to login to the account. A user name and password can be included to establish the communication between the mobile device and the receiving server.

In an aspect, to add to the security of the transaction, a password can be included before the message is sent. For example, after the send button 22 is pressed, a password screen might be displayed, asking for a confirmation password before the message can be sent. The password can be an alphanumeric password, for example, one can be entered through the keypad 21. The password can be a biometric password, for example, a fingerprint or a retina scan password. For biometric password, the mobile device can include a biometric password module. The inputs for the OTP algorithm can include features that unique to the mobile phone, or any other pre-arranged information such as personal information, a security key or password.

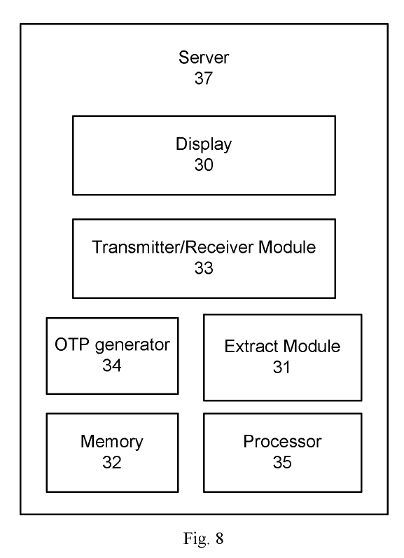

FIG. 8 illustrates an exemplary receiver server 37 according to an embodiment of the present invention. The receiving server 37 comprises a display 30 to view the received message, e.g., a transaction request, sent by the mobile device. The receiving server 37 further comprises an OTP generator 34 to generate a matching OTP to be compared with the OTP included in the message. The receiving server 37 also comprises a transmitter and receiver module 23 to communicate with the mobile device. The receiving server 37 also comprises an extraction module 31 to extract the OTP from the message, for example, if the OTP is included or embedded in the message. Other module can be included, such as a memory 32 for storing information.

The identification of the mobile device can also be retrieved, received or extracted from the message. The identification of the mobile device allows the OTP generator 34 to generate the matching OTP to authenticate the mobile device. The identification of the mobile device can serve to retrieve data or information stored in an account identified by the identification of the mobile device. The retrieved information can also be input to the OTP generator 34 to enhance the security of the OTP strength.

The OTP generator 34 can be similar to the OTP generator 24 of the mobile device 27. For example, they can contain the same algorithm, and thus with same inputs, will generate the same OTP to be compared. The inputs to the OTP generator can be pre-arranged between the mobile device and the receiver server, so that with an identification of the mobile device is adequate to retrieve these additional inputs.

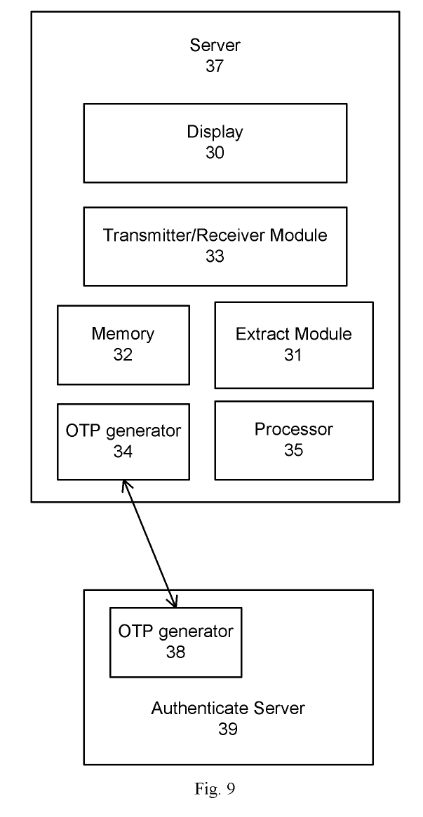

FIG. 9 illustrates an exemplary receiver server 37 communicating with an authenticate server 39 to authenticate the message from the mobile device. In an aspect, the authenticate process is delegated to a separate authenticate server 39, and thus the receiver server 37 can focus on delivery service. The authenticate server 39 can comprise an OTP generator 38, which can generate a matching OTP with the mobile device identification. The identification can be used to identify the account of the sender/sender device, and additional inputs can be retrieved from the account to run the OTP generator.

The authenticate server 39 can deliver the matching OTP to the receiving server 37 so that the receiving server 37 can perform the matching OTP at the receiving server 37. Alternatively, the authenticate server 39 can perform the OTP matching, and returns to the receiving server a positive or a negative authentication regarding the message. In this case, the OTP can be forwarded to the authenticate server 39 from the receiving server 37, in addition to the sender/sender device identification. Separate authenticate server can allow one central server to service the authentication needs for multiple receiving server.

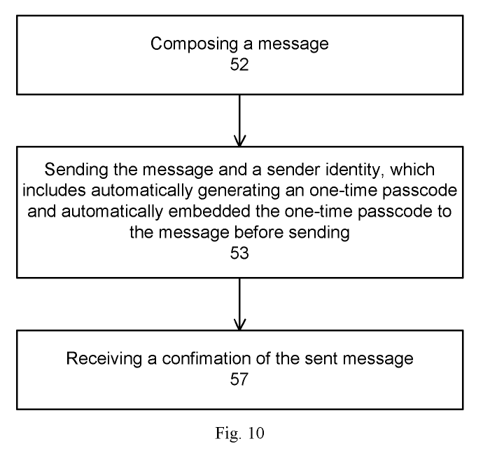

FIG. 10 illustrates an exemplary process for authenticating transmitting messages. Operation 52 composes a message at a sender/sender device, such as a mobile device. The message can be a transaction request, an information retrieval, or the like. Operation 53 sends the message and sender/sender device identification, from the sender/sender device to the receiver server. The sender/sender device identification can be a telephone number of the sender/sender device, or account information of the sender/sender device. The message and the sender/sender device identification can be sent separately, or can be sent together. For example, in the telephone identification, the telephone number is usually sent ahead when establishing the communication before sending the message. Also, the sender/sender device generates an OTP to be sent to the receiving server. The OTP can be included in the message, or can be sent separately. The OTP can be automatically generated, for example, before, during or after finishing the message. For example, when the sender/sender device sends the message, e.g., pressing the send button, this action can activate the OTP module to generate and embedded an OTP to the message to be sent. After sending the message, operation 57 receives a return message from the receiving server. The return message can be a confirmation of the message, an acknowledgement of the message and the performance of the instructions within the message. The confirmation can serve to be a proof of the transaction request, and the acknowledgement that the instruction has been performed. The return message can be a negative confirmation, to signify that the receiving server cannot authenticate the sender/sender device, and thus no instruction can be performed.

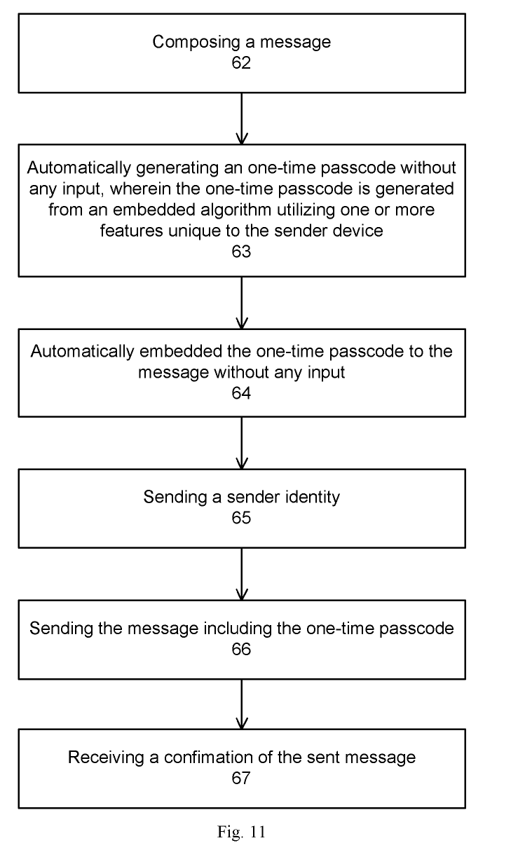

FIG. 11 illustrates another exemplary process for authenticating transmitting messages. Operation 62 composes a message at a sender/sender device, such as a mobile device. Operation 63 automatically generates an OTP without any input, wherein the OTP is generated from an embedded algorithm utilizing one or more features unique to the sender/sender device. The embedded algorithm can be stored in the sender device, in the form of either software or hardware component. The features unique to the sender/sender device can include the phone number of the mobile device, the identity of the equipment, the version of the OTP algorithm, the security key for the mobile device, and the password chosen by the mobile device. Operation 64 automatically embeds the OTP to the message without any user input. Operation 65 sends a sender/sender device identity to the receiver device, and operation 66 sends the message including the OTP. Operation 64 and 65 can be interchangeable, meaning either operation can be first, or both operations can occur at the same time. The receiver server can authenticate the message, and send a confirmation in operation 67.

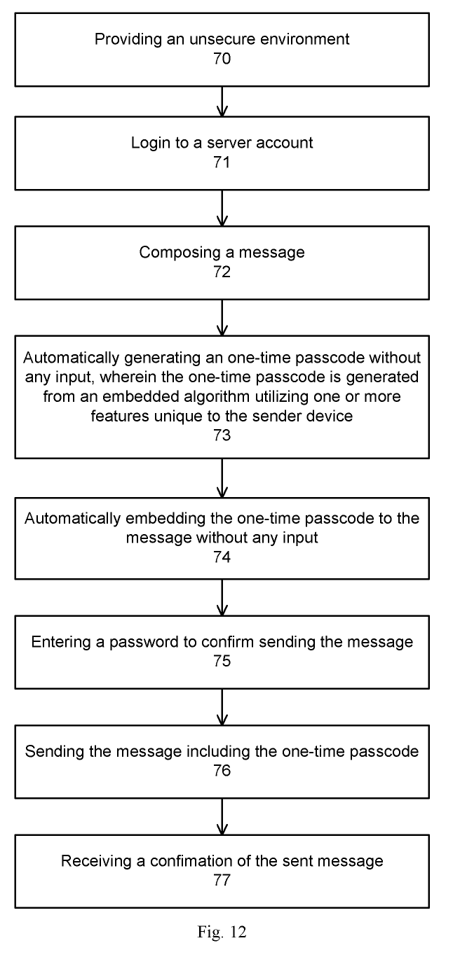

FIG. 12 illustrates another exemplary process for authenticating transmitting messages. Operation 70 provides an unsecured environment, such as a wireless communication environment. Operation 71 provides that the sender logins to a server account, for example, to the account that the sender wants to perform some transactions. The user name of the account can be used to establish the identity of the sender/sender device. A password might be needed to secure the account access. Operation 72 provides that the sender/sender device composes a message, for example, a transaction request to be performed on the account at the receiving server. Operation 73 automatically generates an OTP without any input from the sender/sender device, with the OTP generated from an embedded algorithm utilizing one or more features unique to the sender/sender device. Operation 74 automatically embedded the generated OTP to the message, again without any input from the sender/sender device. Operation 75 provides that the sender/sender device enters a password to confirm the sending of the message. The password can be an alphanumeric or a biometric password. After confirming the desire to send the message, operation 76 sends the message, including the OTP. The user account can be used to establish the identity of the sender/sender device. Also, additional identity of the sender/sender device can also be sent, such as the phone number of the mobile device. After sending the message, the sender/sender device receives confirmation from the receiving server, notifying that either the message is authenticated and the transaction performed, or the message is not authenticated, and no action is performed.

For example, the receiving server can be a bank server where the bank provides a logon page displayed by the customer's browser having a window in which the customer can type in a userID and a password generated by their personal token. The bank then transmits this information to the authenticate server in a secure manner in the form of an authentication request. The authenticate server generates an authentication response in the form of a simple pass or fail result. If the customer is authenticated then access to the web site is granted in the normal manner. A consumer may have a number of Internet bank accounts with different banks. Provided the banks are clients of the remote authentication service provider, the user need only maintain a single hardware token for generating passwords.

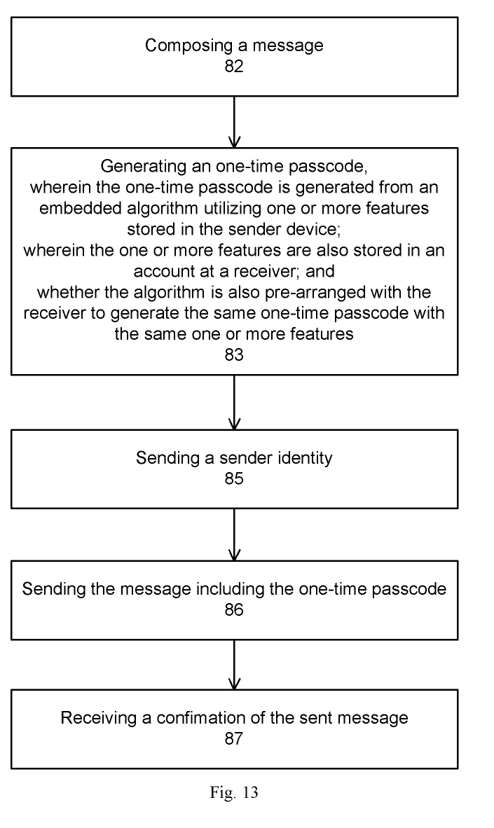

FIG. 13 illustrates another exemplary process for authenticating transmitting messages. The generated OTP for authenticating the sender/sender device uses pre-arranged algorithm and/or pre-arranged inputs between the sender/sender device and the receiver. The pre-arranged information at the sender/sender device can be embedded in the sender device, such as the mobile device. The pre-arranged information at the receiver can be stored in an account at the receiver. Thus information has been pre-arranged, and no sensitive information is transmitted between the sender/sender device and the receiver. Operation 82 composes a message by the sender/sender device. Operation 83 generates an OTP, using pre-arranged information between the sender/sender device and the receiver. Operation 85 sends a sender/sender device identity, such as a telephone number, or a user name for accessing the account at the receiver. Operation 86 sends the message including the OTP. Operations 85 and 86 can be sent in either order, or can be sent together. After sending, operation 87 receives a confirmation from the receiver.

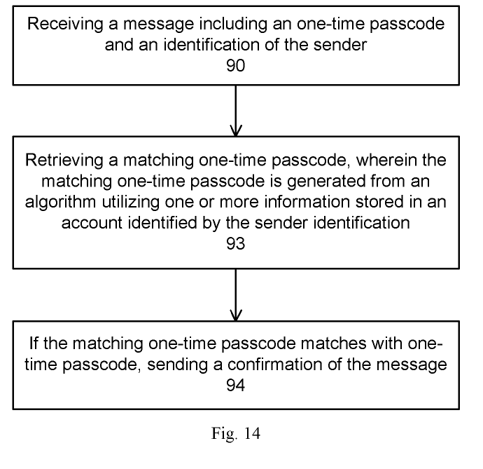

The present invention also includes an authentication process from the receiving server. FIG. 14 illustrates an exemplary process for authenticating a received message. Operation 90 provides that the receiver server receives the message including the OTP and an identification of the sender/sender device. Operation 93 retrieves a matching OTP, by the receiving server. The matching OTP can be generated by an algorithm utilizing one or more information stored in an account at the receiving server. The account can be identified by the identification of the sender/sender device. Operation 94 sends a confirmation of the message, together with executing the instructions within the message if the matching OTP matches with the OTP embedded in the message. If not matched, negative confirmation can be sent.

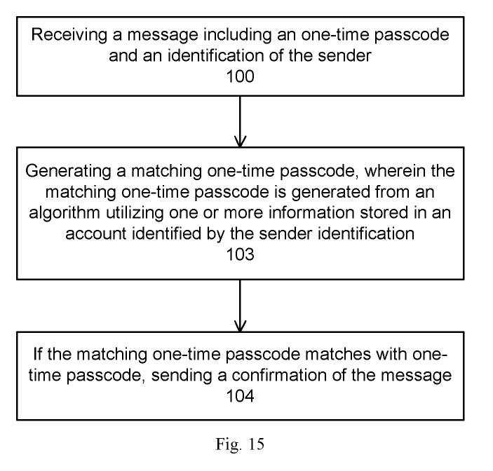

FIG. 15 illustrates another exemplary process for authenticating a received message. The receiving server has an algorithm to generate OTP, and thus can generate the matching OTP to compare with the extracted OTP within the message. Operation 100 receives, by the receiving server, a message including an OTP and a sender/sender device ID. Operation 103 generates, by the receiving server, a matching OTP using an algorithm stored in the receiving server, together with one or more information stored in an account at the receiving server identified by the sender/sender device ID. If matched, the receiving server sends confirmation to the sender/sender device (operation 104)

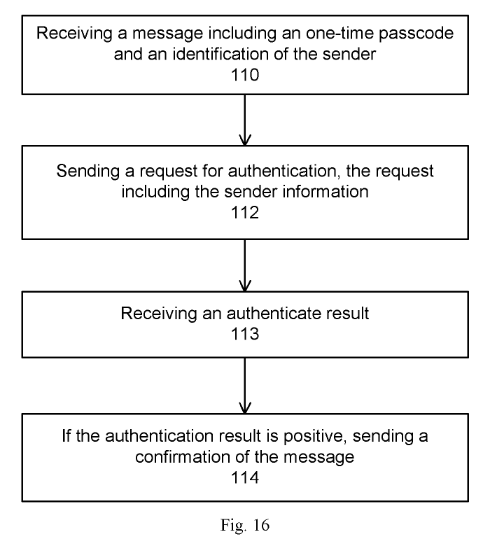

FIG. 16 illustrates another exemplary process for authenticating a received message. The receiving server employs an authenticate server for authenticate the message instead of generating the OTP at the receiving server. Operation 110 receives, by the receiving server, a message including an OTP and a sender/sender device ID. Operation 112 sends, from the receiving server to an authenticate server, a request for authentication. The request includes the sender/sender device ID. In an aspect, the request includes the OTP extracted from the message. Operation 113 receives, by the receiving server from the authenticate server, an authenticate result. The authenticate result can be a matching OTP generated from an embedded algorithm within the authenticate server. The authenticate result can be a result of matching the matching OTP generated from an embedded algorithm within the authenticate server and the OTP extracted from the message. Operation 114 sends, by the receiving server to the sender/sender device, a confirmation of the message if the authenticate result is positive. In the case that the authenticate result is a matching OTP, a match between the matching OTP and the extracted OTP shows that the authentication result is positive. In the case that the authenticate result is a result of matching the two OTPs, a positive result shows that the authentication result is positive.

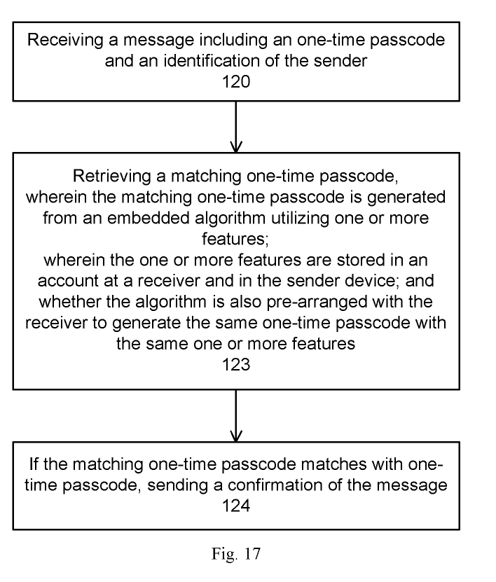

FIG. 17 illustrates another exemplary process for authenticating a received message. The authentication process employs pre-arranged OTP algorithm and inputs between the sender/sender device and either the receiving server or the authenticate server. Operation 120 receives, by the receiving server, a message including an OTP and a sender/sender device ID. Operation 123 retrieving, either by generating or by receiving from an authenticate server, an authentication result which is the result of an embedding OTP algorithm. Operation 124 sends confirmation if authentication is confirmed.

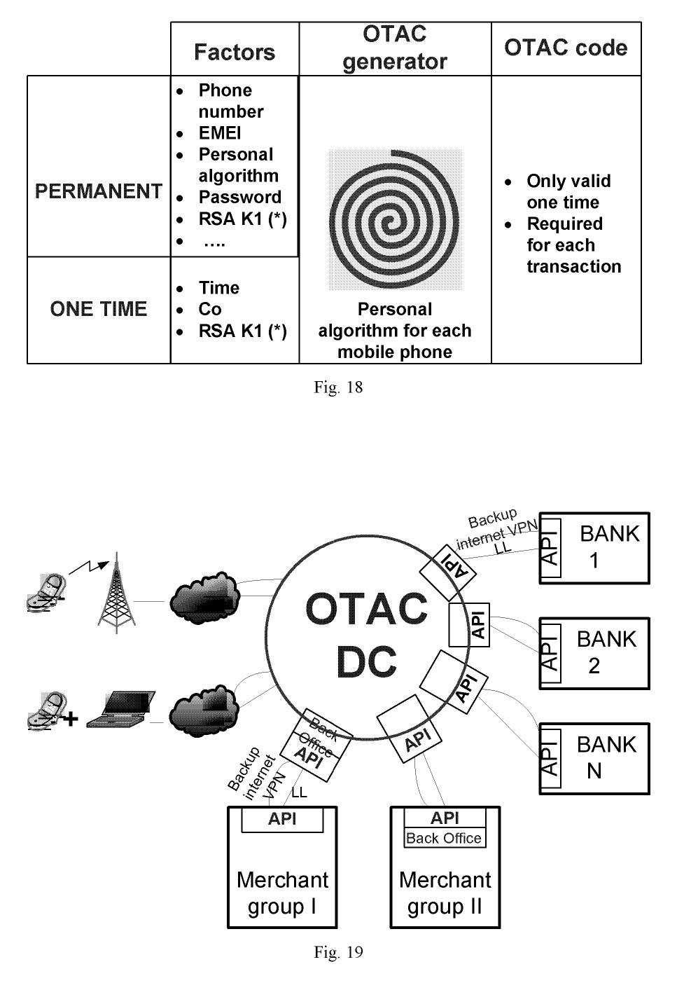

FIG. 18 illustrates an exemplary multi-factor OTAC generator according to an embodiment of the present invention. The factors can be either permanent or one time. The permanent factors can include the phone number, the IMEI, the personal algorithm to generate the passcode, the password, and the encryption factor RSA K1. The one time factor can include the time of sending the message, the response Co from the receiving server, and the encryption factor RSA K1. The RSA K1 factor can be either permanent or one time, for example, the RSA K1 factor will be changed at each transaction if the one time encryption method is used. These factors can be inputted to the OTAC generator, which can be a personal algorithm for each mobile device. The OTAC code is valid for only one time, and a new one is generated for each transaction.

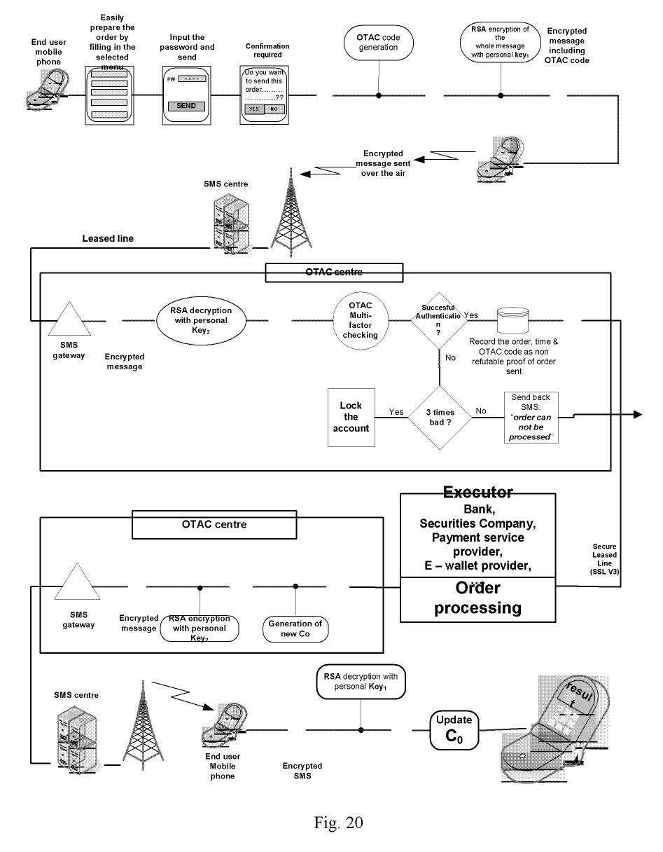

FIG. 19 illustrates an exemplary environment of the present OTAC process. An OTAC central system can serve a number of banks and merchant groups through a network interface. The OTAC central system can receive transaction messages from a mobile phone, a laptop, or from a link to the Internet.

FIG. 20 illustrates an exemplary OTAC level 2 authentication and certification process according to an embodiment of the present invention, utilizing one-time Co factor from the receiving server. The end user uses his mobile phone to prepare the transaction order. The order can be easily prepared by filling in the selected menu. At the completion of the order preparation, the user can enter a password to send the order transaction. The mobile phone can then present a confirmation menu before sending the message. Before sending, the mobile device generates an OTAC code, utilizing at least the one time Co factor stored in the mobile device, and includes the OTAC code within the message. The composite message, including the OTAC code, is then encrypted with a personal key k1 and then sent to a receiving server OTAC center.

At the receiving server, the encrypted message is descrambled with key k2 to generate the order transaction and the OTAC passcode. The OTAC passcode is authenticated, and if successful, the server records the order, the time and the OTAC code as anon refutable proof of the order. The order is then sent to the executor, e.g., the bank, the security company, the payment service provider, or the e-wallet provider, etc. for processing. If the OTAC passcode fails the authentication process, the receiving server sends back a message refusing to process the order. In addition, to increase the security, the number of authentication failures is recorded, and if the number exceeds a certain predetermined value, e.g., 3 times, the server locks the account.

The OTAC center also receives the result from the order processing at the executor enter, and generates a new Co factor. The result and the new Co factor are encrypted with the key k2, and send back to the mobile phone of the end user as a confirmation. At the mobile phone, the confirmation is descrambled with the personal key k1 to separate the result and the new Co factor. The new Co factor is used to update the previous Co in the mobile phone, thus the one-time passcode used in the present process utilizes a one-time Co factor, received from the receiving server. With the time lag, meaning a previously-sent Co is used in the current message, the number of message transferred between the mobile device and the receiving server can be kept to a minimum.

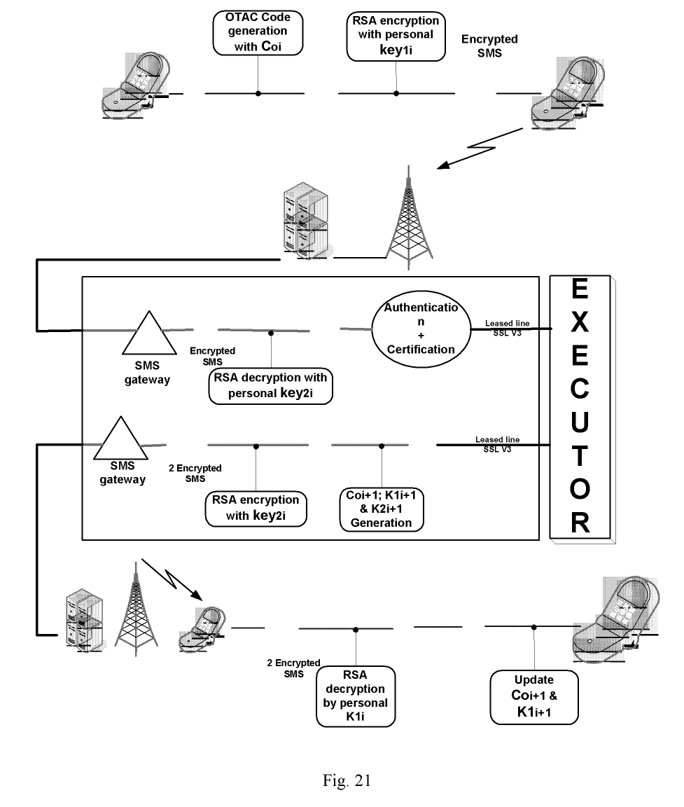

FIG. 21 illustrates an exemplary OTAC level 3 authentication and certification process according to an embodiment of the present invention, utilizing one-time Co factor from the receiving server together with a one-time encryption key. In this process, a new encryption key is generated in addition to the new Co factor, and both the new encryption key and the new Co factor are included in the confirmation sent back to the mobile device. After descrambling the confirmation with the previous encryption key k1, the new encryption key and the new Co factor are updated in the mobile phone. Thus both the encryption key and the receiving factor Co are one-time, thus increasing the security of the present mobile transaction.

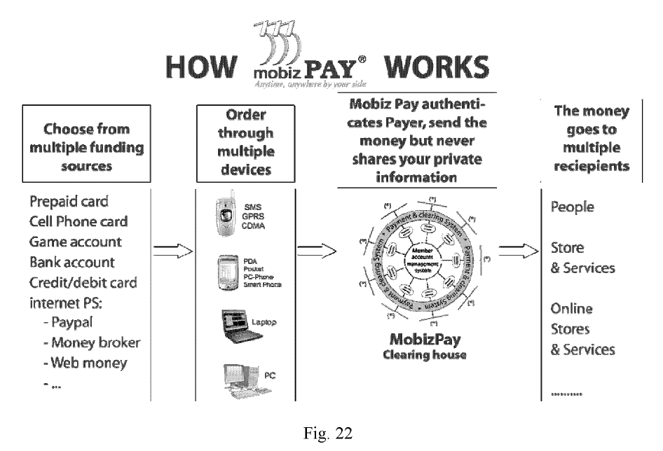

This invention and these methods can be applied to any application or service that requires strong authentication of the RE, using a MD. Some of the relevant business applications for this technology include, but are not limited to, remote payment, mobile payment, online payment, mobile commerce, e-banking, mobile banking, mobile e-banking, mobile or remote signature, stock trading online, mobile stock trading, mobile phone authentication and certification center, mobile betting, and certified text messaging. FIG. 22 illustrates an exemplary payment environment of the present invention illustrating the possible applications of the present invention. The user can select from multiple funding sources, such as prepaid card, cell phone card, game account, bank account, credit or debit card, Internet payment scheme such as a PayPal, money broker, or web money, and the like. The user can order the service or transaction from multiple device, such as cell phone (SMS, GPRS, or CDMA, etc.), PDA (pocket, PC-phone, smart phone, etc.), laptop computer, desktop computer, or ATM machine. The present server hub can authenticate the payer and send the money, all without disclosing or sharing the private or sensitive information of the payer. The payment can be sent to multiple location and recipients, such as people, stores or services, or online stores or services, etc.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method for secure transmission of information, comprising:
composing, at a sender device, a message;
automatically generating a one-time passcode to be included in the message before sending, wherein the one-time passcode is generated from an embedded algorithm utilizing one or more features unique to the sender device;
sending, from the sender device to a receiver device, the message including the one-time passcode for securely authenticating the sender identity; and
receiving, from the receiver device, a confirmation of the message.

2. A method as in claim 1 wherein the one-time passcode is automatically generated and included in the message without requiring a sender input.

3. A method as in claim 1 further comprising
identifying, at the sender device, a sender identification before composing the transaction request.

4. A method as in claim 1 further comprising
identifying, at the sender device, a sender identification at the sending of the transaction request.

5. A method as in claim 1 wherein the sender identification comprises the phone number of the sender device.

6. A method as in claim 1 wherein the sender device comprises one of a mobile device, a cell phone, a personal device assistance (PDA), a pocket PC, a laptop, and a smart phone.

7. A method as in claim 1 wherein the receiver device comprises one of a mobile device, a cell phone, a personal device assistance (PDA), a pocket PC, a laptop, a smart phone, a computer, and a server.

8. A method as in claim 1 wherein the features unique to the sender device comprise at least one of the International Mobile Equipment Identity (IMEI), the unique industrial ID number for the mobile device, the Electronic Serial Number of the mobile device, and the version of the algorithm.

9. A method as in claim 1 wherein the algorithm further utilizes one or more features unique to the sender, the features comprising at least one of a security key for the sender, a password chosen by the sender, and a personal information of the sender.

10. A method as in claim 1 further comprising
entering, at the sender device, a password, before composing the transaction request.

11. A method as in claim 1 wherein the password comprises a biometric password comprising one of a retina scan, a fingerprint, and a picture of the sender.

12. A method as in claim 1 further comprising
entering, at the sender device, a password, before generating the one-time passcode.

13. A method as in claim 1 wherein the password comprises a biometric password comprising one of a retina scan, a fingerprint, and a picture of the sender.

14. A method as in claim 1 wherein the transaction comprises at least one of a remote payment, a mobile payment, an online payment, a contact-less payment, a contact-less transaction, a mobile commerce, an e-banking transaction, a mobile banking transaction, a mobile e-banking transaction, a mobile signature, a remote signature, an online stock trading transaction, a mobile stock trading transaction, a mobile phone authentication, a mobile betting, a mobile gambling, a mobile ticketing, a mobile wallet, a mobile financial transaction and a certified text message.

15. A method as in claim 1 wherein the message is encrypted with a one-time encryption key.

16. A method as in claim 1 wherein no private or confidential information is sent during the transmission of information.

17. A method as in claim 1 wherein the algorithm further utilizes a unique security code sent from the receiving server during a previous confirmation message.

18. A system for secure transmission of information, comprising:
means for composing a message;
means for automatically generating a one-time passcode to be included in the message before sending, wherein the one-time passcode is generated from an embedded algorithm utilizing one or more features unique to the system;
means for sending the message including the one-time passcode for securely authenticating the sender identity; and
means for receiving a confirmation of the message.

19. A system as in claim 18 wherein the one-time passcode is automatically generated and included in the message without requiring a sender input.

20. A system as in claim 18 further comprising
means for identifying a sender identification before composing the transaction request.

21. A system as in claim 18 further comprising
means for entering a password before generating the one-time passcode.

22. A method for secure transmission of information, comprising:
composing, at a sender device, a message;
generating a one-time passcode, wherein the one-time passcode is generated from an embedded algorithm utilizing one or more features stored in the sender device, the one or more feature also stored in an account at a receiver, and the algorithm is pre-arranged with the receiver to generate the same one-time passcode utilizing the same one or more features;
sending, from the sender device to a receiver device, the message including the one-time passcode for securely authenticating the sender identity; and
receiving, from the receiver device, a confirmation of the message.

23. A method as in claim 22 wherein the one-time passcode is automatically generated and included in the message without requiring a sender input.

24. A method as in claim 22 further comprising
identifying, at the sender device, a sender identification before composing the transaction request.

25. A method as in claim 22 further comprising
entering, at the sender device, a password before generating the one-time passcode.

26. A method as in claim. 22 wherein the message is encrypted with a one-time encryption key.

27. A method as in claim 22 wherein no private or confidential information is sent during the transmission of information.

28. A method for secure transmission of information, comprising:
receiving, from a sender device to a receiver device, a message including a one-time passcode and an identification of the sender;
retrieving, at the receiver device, a matching passcode, wherein the matching passcode is generated from an algorithm utilizing one or more information stored in an account identified by the sender identification;
if the matching passcode matched with the one-time passcode,
sending, from the receiver device to the sender device, a confirmation of the message.

29. A method as in claim 28 further comprising
executing, at the receiver device, a request included in the message.

30. A method as in claim 28 wherein retrieving a matching passcode comprises:
generating the matching passcode at the receiver device.

31. A method as in claim 28 wherein retrieving a matching passcode comprises:
sending, from the receiver device to a server, a request for authentication including the sender information;
receiving, at the receiver device from the server, the matching passcode.

32. A method as in claim 28 wherein the sender identification comprises the phone number of the sender device.

33. A method as in claim 28 wherein the receiver device comprises one of a mobile device, a cell phone, a personal device assistance (PDA), a pocket PC, a laptop, a smart phone, a computer, and a server.

34. A method as in claim 28 wherein the information stored in the account identified by the sender identification comprises at least one of the International Mobile Equipment Identity (IMEI), the unique industrial ID number for the mobile device, the Electronic Serial Number of the mobile device, and the version of the algorithm.

35. A method as in claim 28 wherein the information stored in the account identified by the sender identification comprises at least one of a security key for the sender, a password chosen by the sender, and a personal information of the sender.

36. A method as in claim 28 wherein the transaction comprises at least one of a remote payment, a mobile payment, an online payment, a mobile commerce, an e-banking transaction, a mobile banking transaction, a mobile e-banking transaction, a mobile signature, a remote signature, an online stock trading transaction, a mobile stock trading transaction, a mobile phone authentication, a mobile betting, and a certified text message.

37. A method as in claim 28 wherein the message is encrypted with a one-time encryption key.

38. A method as in claim 28 wherein no private or confidential information is sent during the transmission of information.

39. A method as in claim 28 further comprising
recording the one-time passcode to certify the authentication of the message.

40. A method for secure transmission of information, comprising:
receiving, from a sender device to a receiver device, a message including a one-time passcode and an identification of the sender;
retrieving, at the receiver device, a matching passcode,
wherein the matching passcode is generated from an algorithm utilizing one or more information stored in an account identified by the sender identification and in the sender device; and
wherein the algorithm is pre-arranged between the sender device and the receiver device to generate the same one-time passcode for the same one or more features;
if the matching passcode matched with the one-time passcode,
sending, from the receiver device to the sender device, a confirmation of the message.

41. A method as in claim 40 wherein the sender identification comprises the phone number of the sender device.

42. A method as in claim 40 further comprising
recording the one-time passcode to certify the authentication of the message.

43. A mobile device for secure transmission of information, comprising:
a communication module for transmitting and receiving messages;
a keypad module for composing a message, the keypad interface comprising a send feature for transmitting the message;
a one-time passcode generator employing an algorithm utilizing one or more features unique to the mobile device;
a processor for automatically generating and including the one-time passcode to the message before transmission, wherein the one-time passcode is included in the message for securely authenticate the message.

44. A device as in claim 43 wherein the one-time passcode is automatically generated and included in the message without requiring a sender input.

45. A device as in claim 43 further comprising
an identification module for identifying a sender identification before composing the transaction request.

46. A device as in claim 43 wherein the features unique to the sender device comprise at least one of the International Mobile Equipment Identity (IMEI), the unique industrial ID number for the mobile device the Electronic Serial Number of the mobile device, and the version of the algorithm.

47. A device as in claim 43 wherein the algorithm further utilizes one or more features unique to the sender, the features comprising at least one of a security key for the sender, a password chosen by the sender, and a personal information of the sender.

48. A device as in claim 43 further comprising
a password module for entering a password before generating the one-time passcode.

49. A device as in claim 43 further comprising
a one-time encryption module for encrypting the message with a one-time encryption key.

50. A device as in claim 43 further comprising
a security device module for receiving a, security code from a receiving server to use in the generation of the one-time passcode.

51. A server for secure transmission of information, comprising:
a communication module for transmitting and receiving messages;
a module for extracting a sender identification and a one-time passcode from the message;
a one-time passcode generator employing an algorithm utilizing one or more information stored in an account identified by the sender identification;
a processor for comparing the received one-time passcode and the generated one-time passcode,
wherein an acknowledgement is sent if the received one-time passcode matches the generated one-time passcode.

52. A server as in claim 51 wherein the sender identification comprises the phone number of the sender device.

53. A server as in claim 51 wherein the information stored in the account identified by the sender identification comprises at least one of the International Mobile Equipment Identity (IMEI), the unique industrial ID number for the mobile device, the Electronic Serial Number of the mobile device, and the version of the algorithm.

54. A server as in claim 51 wherein the information stored in the account identified by the sender identification comprises at least one of a security key for the sender, a password chosen by the sender, and a personal information of the sender.

55. A system for secure transmission of information, comprising:
a plurality of mobile devices;
a server;
wherein at least one mobile device is configured to composing a message;
automatically generating a one-time passcode to be included in the message before sending, wherein the one-time passcode is generated from an embedded algorithm utilizing one or more features unique to the mobile device;
sending, to the server, the message including the one-time passcode for securely authenticating the sender identity; and
receiving, from the server, a confirmation of the message; and
wherein the server is configured to
receiving, from a mobile device, a message including a one-time passcode and an identification of the sender;
retrieving a matching passcode, wherein the matching passcode is generated from an algorithm utilizing one or more information stored in an account identified by the sender identification;
if the matching passcode matched with the one-time passcode, sending, to the mobile device, a confirmation of the message.

56. A system as in claim 55 wherein the one-time passcode is automatically generated and included in the message without requiring a sender input.

57. A system as in claim 55 wherein the mobile device is further configured to identifying a sender identification before composing the transaction request.

58. A system as in claim 55 wherein the features unique to the sender device comprise at least one of the International Mobile Equipment Identity (IMEI), the unique industrial ID number for the mobile device, the Electronic Serial Number of the mobile device, and the version of the algorithm.

59. A system as in claim 55 wherein the algorithm further utilizes one or more features unique to the sender, the features comprising at least one of a security key for the sender, a password chosen by the sender, and a personal information of the sender.

60. A system as in claim 55 wherein the mobile device is further configured to entering a password before generating the one-time passcode.

61. A system as in claim 55 wherein the algorithm further utilizes a unique security code sent from the receiving server during a previous confirmation message.

62. A system as in claim 55 wherein the information stored in the account identified by the sender identification comprises at least one of the International Mobile Equipment Identity (IMEI), the unique industrial ID number for the mobile device, the Electronic Serial Number of the mobile device, and the version of the algorithm.

63. A system as in claim 55 wherein the information stored in the account identified by the sender identification comprises at least one of a security key for the sender, a password chosen by the sender, and a personal information of the sender.

64. A system as in claim 55 wherein the mobile device is further configured to one-time encrypting the message with a one-time encryption key.

65. A system as in claim 55 wherein the server is further configured to recording the one-time passcode to certify the authentication of the message.
